(19) United States
(12) Patent Application Publication
(10) Pub. No.: US 2002/0137659 A1
(43) Pub. Date: Sep. 26, 2002

(54) Reaction products of polycarboxylic acids derivatives thereof

(76) Inventors: Stephen F. Gross, Souderton, PA (US); Wei Li, Mason, OH (US); Norman Tuller, Simpsonville, SC (US)

Correspondence Address: COGNIS CORPORATION, 2500 RENAISSANCE BLVD., SUITE 200, GULPH MILLS, PA, 19406

(21) Appl. No.: 10/015,479

(22) Filed: Dec. 13, 2001

Related U.S. Application Data
(60) Provisional application No. 60/256,375, filed on Dec. 18, 2000.
(60) Provisional application No. 60/314,361, filed on Aug. 23, 2001.

(51) Int. Cl. C11D 1/00

(52) U.S. Cl. 510/477

(57) ABSTRACT

Low foaming surfactants and/or defoaming agents, which are products of reactants comprising

A) at least one compound having the formula I below

RX(EO)ₙ(PO)ₘ(BO)ₚH (I)

wherein R is a substituted or unsubstituted, saturated or unsaturated, organic group having from 4 to 36 carbon atoms; X is —O—, —S—, or —NR¹—where R¹ is hydrogen or a C₁-C₈ alkyl group; n is a number of from 0 to 100; m is a number of from 0 to 50; and p is a number of from 0 to 50; provided that the sum of n, m, and p is at least 1; wherein EO represents the residue of ethylene oxide, PO represents the residue of propylene oxide, and BO represents the residue of butylene oxide; and wherein the EO, PO, and BO groups when present can be in random and/or block distribution and can be in any order with respect to the X group; and

B) a polycarboxylic acid or derivatives thereof of formula II

R²(COY)ₓ (II)

wherein R² is a substituted or unsubstituted, saturated or unsaturated, organic group having from 3 to 36 carbon atoms, Y is independently halogen, or —OR³ where R³ is hydrogen, a C₁-C₄ alkyl group, or any two —COOR³ groups can form a carboxylic anhydride group; and x is a number of from 3 to 10.

### CROSS REFERENCE TO RELATED APPLICATIONS

This application claims the benefit of copending provisional application serial No. 60/256,375, filed on Dec. 18, 2000, and provisional application serial No. 601314,361 filed on Aug. 23, 2001; the entire contents of each of which are incorporated herein by reference.

### FIELD OF THE INVENTION

This invention relates to compounds useful as low foaming surfactants and as defoaming agents in aqueous and nonaqueous liquid compositions.

### BACKGROUND OF THE INVENTION

Aqueous cleaning compositions exhibit a tendency toward foaming since they contain surface active agents such as soaps, and synthetic detergents. In many instances, such cleaning compositions produce excessive foam and the user must add substances known as anti-foaming agents or defoamers. Some defoamers such as silicones tend to interfere with the function of the cleaning compositions in that unwanted residues are left after the cleaners are wiped off, while others are environmentally unacceptable because they are not biodegradable.

Alkyl polyglycosides are a class of nonionic surfactants that exhibit significantly higher foaming profiles than other nonionic surfactants, such as alcohol ethoxylates. In fact, the foaming tendencies of alkyl polyglycosides more closely resemble those of anionic surfactants, such as alcohol sulfates, than the foaming tendencies of other nonionic surfactants. This higher foaming tendency makes the use of alkyl polyglycosides alone undesirable for many applications, e.g. cleaning-in-place for food processing plants, high pressure spray cleaning, bottle washing, floor cleaners, and automatic dishwashing, wherein high levels of foam interfere with the cleaning and rinsing operation and reduce the efficiency of the operation.

Low foam nonionics, such as EO/PO block copolymers, can be used to reduce the foaming properties of alkyl polyglycosides and anionic surfactants, but these materials have undesirable properties, e.g. low biodegradability, relatively high aquatic toxicity, and poor caustic compatibility.

Accordingly, there is a need for the development of defoamers that do not interfere with the cleaning ability of aqueous cleaning compositions and that are biodegradable, exhibit low aquatic toxicity, and good caustic compatibility.

There is also a need for defoamers for nonaqueous compositions.

In addition, there is a continuing need for low foaming surfactants for use in both aqueous and nonaqueous compositions.

### SUMMARY OF THE INVENTION

This invention relates to the reaction products of alkoxylated compounds and polycarboxylic acids useful as low foaming surfactants and as defoaming agents in aqueous and nonaqueous liquid compositions.

In particular, the reaction products of the invention are the reaction products of the following reactants:

A) at least one compound of formula I

RX(EO)ₙ(PO)ₘ(BO)ₚH (I)

wherein R is a substituted or unsubstituted, saturated or unsaturated, organic group having from 4 to 36 carbon atoms; X is —O—, —S—, or —NR¹—where R¹ is hydrogen or a C₁-C₈ alkyl group; n is a number of from 0 to 100, e.g. from 1 to 100; m is a number of from 0 to 50, e.g. from 1 to 50; and p is a number of from 0 to 50, e.g. from 1 to 50; provided that the sum of n, m, and p is at least 1; wherein EO represents the residue of ethylene oxide, PO represents the residue of propylene oxide, and BO represents the residue of butylene oxide; and wherein the EO, PO, and BO groups when present can be in random and/or block distribution and can be in any order with respect to the X group; and

B) a polycarboxylic acid or derivatives thereof of formula II

R²(COY)ₓ (II)

wherein R² is a substituted or unsubstituted, saturated or unsaturated, organic group having from 3 to 36 carbon atoms, preferably from 4 to 36 carbon atoms; Y is independently halogen, e.g. Cl, Br, or I, or —OR³ where R³ is hydrogen, a C₁-C₄ alkyl group, or any two —COOR³ groups can form a carboxylic anhydride group; and x is a number of from 3 to 10.

The reaction products of A) and B) have the formula III below

| | |
|---|---|
| (COOR³)f | |
| \| | |
| R²(CO(OB)ₚ(OP)ₘ(OE)ₙXR)_{g} | (III) |

wherein f+g=x in formula II; g is at least 1 and preferably =x, and R, R², X Y, n, m, and p have the meanings given above; and provided that the products do not contain any —COY groups in which Y=halogen.

### DESCRIPTION OF THE PREFERRED EMBODIMENTS

Other than in the operating examples, or where otherwise indicated, all numbers expressing quantities of ingredients or reaction conditions used herein are to be understood as modified in all instances by the term “about”. Also, throughout this description, unless expressly stated to the contrary; percent “parts” of, and ratio values are by weight; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description or of generation in situ by chemical reactions specified in the description, and does not necessarily preclude other chemical interactions among the constituents of a mixture once mixed.

The R group in formula I can be any substituted or unsubstituted, saturated or unsaturated organic moiety having from 4 to 36 carbon atoms. Thus, the R groups can be linear or branched alkyl groups, linear or branched alkenyl or alkynyl groups, saturated carbocyclic moieties having one or more multiple bonds, saturated heterocyclic moieties, unsaturated heterocyclic moieties having one or more multiple bonds, saturated linear or branched alkyl groups, substituted linear or branched alkenyl or alkynyl groups, substituted saturated carbocyclic moieties, substituted unsaturated carbocyclic moieties having one or more multiple bonds, substituted saturated heterocyclic moieties, substituted unsaturated heterocyclic moieties having one or more multiple bonds, and aryl or arenyl moieties. Examples of the above include but are not limited to an alkyl group having from 4 to 36 carbon atoms, an alkenyl group having from 4 to 22 carbon atoms, and an alkynyl group having from 4 to 22 carbon atoms. R can also be an arenyl group. Arenyl groups are alkyl-substituted aromatic radicals having a free valence at an alkyl carbon atom such as a benzylic group. Aryl groups include those having from 6 to 36 carbon atoms, e.g. phenyl, naphthyl, etc.

Further examples of R groups include substituted or unsubstituted alkyl groups having from 4 to 36 carbon atoms, preferably from 4 to 22 carbon atoms, more preferably from 4 to 12 carbon atoms, and most preferably from 8 to 10 carbon atoms; alkenyl and alkynyl groups having from 4 to 36 carbon atoms, preferably from 4 to 22 carbon atoms, aryl groups having from 6 to 26 carbon atoms, and arenyl groups having from 7 to 36 carbon atoms.

When the R groups are substituted groups, the groups can contain single or multiple substitutions such as a halogen substitution, for example Cl, Fl, I, and Br; a sulfur functionality such as a mercaptan or thio group; a nitrogen functionality such as an amine or amide functionality; a silicon functionality; a C₁-C₄ alkoxy group; or any combination thereof.

In formula I compounds, compounds wherein the sum of n, m, and p is at least 2, especially at least 3, are preferred.

The degree of ethoxylation is preferably from 2 to about 50, more preferably from 3 to about 50, with the most preferred being from 4 to about 50, while the degree of propoxylation and butoxylation can vary from 0 to about 50, e.g. from 0 to about 10. The degree of propoxylation and/or butoxylation will be determined by the desired degree of water solubility and miscibility. The water solubility or miscibility will ultimately be determined by such factors as the number of carbon atoms in R, the relative amounts of EO, PO, and BO and the effect of PO and BO on the biodegradability of the final product will be readily determinable by one of ordinary skill in the art.

When the X group is —NR₁—, the compounds of formula I are alkoxylated amines. When the compounds of formula I are alkoxylated amines, n is a number from 0 to 50, preferably from 1 to 50, m is a number from 0 to 50, and p is a number from 0 to 50, preferably from 1 to 50, provided the sum of n, m, and p is at least 1. Examples of the alkoxylated amines useful for the purposes of the invention include but are not limited to, alkoxylated dibutyl amine, alkoxylated dicyclohexyl amine, alkoxylated diethylethanolamine, and alkoxylated dioctylamine.

Preferred compounds of formula I have the following formula IV:

RO( EO)ₙ(PO)ₘ(BO)ₚH (IV)

in which R, n, m, and p have the meanings given above.

In the compounds of formula I and IV, as stated above for the compounds of formula I, it is understood that EO stands for the residue of ethylene oxide, PO stands for the propylene oxide, and BO stands for the residue of butylene oxide. Also, in the compounds of formula I and IV, the EO, PO, and BO groups, when present, can be in any order with respect to the RX or RO group, and can be in blocks and/or random distribution, although the alkoxide groups present are preferably present in the order shown in formulae I and IV.

In the polycarboxylic acids of formula II, the R² group can be any substituted or unsubstituted, saturated or unsaturated organic moiety having from 3 to 36 carbon atoms. Thus, the R² groups can be linear or branched alkyl groups, linear or branched alkenyl or alkynyl groups, saturated carbocyclic moieties having one or more multiple bonds, saturated heterocyclic moieties, unsaturated heterocyclic moieties having one or more multiple bonds, saturated linear or branched alkyl groups, substituted linear or branched alkenyl or alkynyl groups, substituted saturated carbocyclic moieties, substituted unsaturated carbocyclic moieties having one or more multiple bonds, substituted saturated heterocyclic moieties, substituted unsaturated heterocyclic moieties having one or more multiple bonds, and aryl or arenyl moieties. Examples of the above include but are not limited to an alkyl group having from 4 to 22 carbon atoms, an alkenyl group having from 4 to 22 carbon atoms, and an alkynyl group having from 4 to 22 carbon atoms. R² can also be an arenyl group having from 7 to 36 carbon atoms. Alkyl groups having from 3 to 12 carbon atoms are preferred, and alkyl groups having from 4 to 10 carbon atoms are most preferred. When the above groups are substituted groups, the groups can contain single or multiple substitutions such as a halogen substitution, for example Cl, Fl, I, and Br; an ether group; a sulfur functionality such as a mercaptan or thio group; a nitrogen functionality such as an amine or amide functionality; a silicon functionality; a C₁-C₄ alkoxy group; or any combination thereof.

The x group in formula II is preferably a number from 3 to 6.

Examples of compounds of formula II include 1, 2, 3, 4-butanetetracarboxylic acid, 1, 2, 3-propanetricarboxylic acid, 1, 4, 6-phenyltricarboxylic acid, 1, 2, 3, 4-butanetetracarbonyl chloride, and the like.

The equivalent ratio of the compounds of formula I and the —COY groups of formula II (wherein carboxylic anhydride groups count as two —COY groups) used to prepare the reaction products of the invention can range from 2:1 to 1:1, preferably from 1.2:1 to 1:1. and more preferably about 1:1. Greater quantities of the compounds of formula I can be used but no advantages result therefrom.

The reaction between reactants A) and B) can be carried out by reacting the components at a temperature in the range of from 90 to 150° C., preferably from 130 to 140° C. The reaction is carried out using an acid catalyst, e.g. p-toluenesulfonic acid. The reaction is preferably carried out in an inert atmosphere such as a nitrogen atmosphere.

The reaction products of the invention can be used as low foaming surfactants in both aqueous and nonaqueous compositions in surfactant-effective amounts, usually from 0.1 to 10% by weight, preferably from 1 to 5% by weight, based on the weight of the composition.

These reaction products can also be used in the above quantities as defoaming agents for aqueous and nonaqueous compositions, and are particularly useful in minimizing or eliminating foaming in aqueous compositions containing high foaming surfactants, such as alkyl polyglycosides and anionic surfactants such as alcohol sulfates.

These reaction products can be used in aqueous cleaning compositions, in emulsion polymer latex compositions such as latex paints, in inks, in adhesives, in metal working compositions, and in other aqueous and nonaqueous compositions in which surfactants and/or defoaming agents are advantageously present.

The reaction products of the invention are biodegradable, contain no organic solvents, and do not adversely affect the detergency of other surfactants that may be present in the compositions in which they are used since they themselves are surfactants.

The invention will be illustrated but not limited by the following example.

### EXAMPLE

### Synthesis of 1.2.3.4-Butanetetracarboxylic Acid Esterified with POE (6) Tridecyl Alcohol

1,2,3,4-Butanetetracarboxylic acid (23.4 g, 0.10 mole), POE (6) Tridecyl alcohol (186.0, 0.40 mole), toluene (100 ml), and p-toluenesulfonic acid (1.0 g) were charged to a 1000 ml three neck flask which was equipped with a Dean and Stark trap, a nitrogen inlet, and a thermometer. The flask was purged with nitrogen for 30 minutes while stirring, and then heated up to 140° C. The water formed was collected in a Dean and Stark trap and the reaction was continued until no more water was produced (24 hours). The solution was then cooled and washed first with a saturated sodium bicarbonate solution and then by a saturated sodium chloride solution, and dried over anhydrous sodum sulfate and filtered.

What is claimed is:

1. The reaction product of the reaction between reactants comprising
A) at least one compound having the formula I below
RX(EO)ₙ(PO)ₘ(BO)ₚH (I)
wherein R is a substituted or unsubstituted, saturated or unsaturated, organic group having from 4 to 36 carbon atoms; X is —O—, —S—, or —NR¹— where R¹ is hydrogen or a C₁-C₈ alkyl group; n is a number of from 0 to 100; m is a number of from 0 to 50; and p is a number of from 0 to 50; provided that the sum of n, m, and p is at least 1; wherein EO represents the residue of ethylene oxide, PO represents the residue of propylene oxide, and BO represents the residue of butylene oxide; and wherein the EO, PO, and BO groups when present can be in random and/or block distribution and can be in any order with respect to the X group; and
B) a polycarboxylic acid or a derivative thereof of formula II
R²(COY)ₓ (II)
wherein R² is a substituted or unsubstituted, saturated or unsaturated, organic group having from 3 to 36 carbon atoms; Y is independently halogen, or —OR³ where R³ is hydrogen, a C₁-C₄ alkyl group, or any two —COOR³ groups can form a carboxylic anhydride group; and x is a number of from 3 to 10.

2. The reaction product of claim 1 wherein in component A) the sum of n, m, and p is at least 2.

3. The reaction product of claim 2 wherein the sum of n, m, and p is at least 3.

4. The reaction product of claim 1 wherein in component A), R is an alkyl group containing from 4 to 12 carbon atoms.

5. The reaction product of claim 4 wherein the alkyl group contains from 8 to 10 carbon atoms.

6. The reaction product of claim 1 wherein in component A), X is —O—.

7. The reaction product of claim 1 wherein in component A), X is —NR¹—.

8. The reaction product of claim 1 wherein in component A), n is a number of from 2 to about 50.

9. The reaction product of claim 1 wherein component A) has the formula
RO(EO)ₙ(PO)ₘ(BO)ₚH (I)
where R, n, m, and p have the meanings given in claim 1.

10. The reaction product of claim 9 wherein R is an alkyl group containing from 4 to 12 carbon atoms and n is a number of from 4 to about 50.

11. The reaction product of claim 9 wherein the alkoxide groups present are present in the order shown in formula III.

12. The reaction product of claim 1 wherein in component A) the alkoxide groups present are present in the order shown in formula I.

13. The reaction product of claim 1 wherein in component B), Y in formula II is —OH.

14. The reaction product of claim 9 wherein in component B), Y in formula II is —OH.

15. The reaction product of claim 1 wherein the equivalent ratio of the at least one compound of formula I and the —COY groups of formula II is from about 2:1 to about 1:1.

16. The reaction product of claim 15 wherein said ratio is from about 1.2:1 to about 1:1.

17. The reaction product of claim 1 wherein the x group in formula II is a number of from 3 to 6.

18. The reaction product of claim 9 wherein the x group in formula II is a number of from 3 to 6.

19. The reaction product of claim 9 wherein the R² group in formula II is an alkyl group having from 3 to 12 carbon atoms.

20. The reaction product of claim 1 wherein R in component A) is an unsubstituted group and the EO, PO, and BO groups when present are in the order shown in formula I.

21. The reaction product of claim 9 wherein R in component A) is an unsubstituted group, and the EO, PO, and BO groups when present are in the order shown.

22. A reaction product of claim 1 wherein the reaction product has the formula 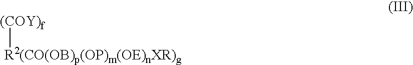
wherein f+g=x in formula II; g is at least 1 and R, R², X, Y, n, m, and p have the meanings given in claim 1; and provided that the reaction product does not contain any —COY groups in which Y=halogen.

23. The reaction product of claim 22 wherein f=0 and g=x in formula II.

24. The reaction product of claim 23 wherein X is oxygen, and R and R² are alkyl groups.

25. In an aqueous composition, the improvement wherein a surfactant-effective or defoaming-effective quantity of the reaction product of claim 1 is present therein.

26. The composition of claim 25 wherein the surfactant-effective or defoaming-effective quantity is from about 0.1 to 10% by weight.

27. The composition of claim 25 wherein the composition is a latex paint composition.

28. In an aqueous composition containing an alkyl polyglycoside and/or an alcohol sulfate the improvement wherein a defoaming-effective quantity of the reaction product of claim 1 is present therein.

29. In a nonaqueous liquid composition, the improvement wherein a surfactant-effective or defoaming-effective quantity of the reaction product of claim 1 is present therein.

30. The nonaqueous liquid composition of claim 29 wherein the composition is an ink, an adhesive or a metal working composition.

31. The nonaqueous liquid composition of claim 29 wherein the surfactant-effective quantity is from about 0.1 to about 10% by weight.
